(19) United States
(12) Patent Application Publication
(10) Pub. No.: US 2018/0292060 A1
(43) Pub. Date: Oct. 11, 2018

(54) LIGHT MODULE FOR A MOTOR VEHICLE INCLUDING A SEMICONDUCTOR LIGHT SOURCE

(71) Applicant: VALEO VISION, Bobigny Cedex (FR)

(72) Inventors: Francois BERREZAI, Bobigny Cedex (FR); Benoit DELANDE, Bobigny Cedex (FR)

(73) Assignee: VALEO VISION, Bobigny Cedex (FR)

(21) Appl. No.: 15/946,786

(22) Filed: Apr. 6, 2018

(30) Foreign Application Priority Data
Apr. 7, 2017 (FR) 17 53057

(51) Int. Cl. F21S 41/16; F21V 17/04; F21S 41/32; B60Q 1/04

(52) U.S. Cl. CPC F21S 41/16; B60Q 1/04; F21S 41/32; F21V 17/04

(57) ABSTRACT

A light module including a semiconductor light source, an optical reflector that is positioned with respect to the light source, and a reference surface, belonging to a heat sink radiator, on which the light source and the optical reflector are fastened, wherein the light source is supported by a mount that is fastened on the reference surface. The light module includes means for adjusting the position of the mount with respect to the reference surface and means for fastening the mount, in the adjusted position, on the reference surface.

### TECHNICAL FIELD OF THE INVENTION

The invention relates to a light module used in the field of lighting and/or light signalling, in particular for a motor vehicle.

The invention relates more particularly to a light module including at least one semiconductor light source that is associated with an optical component that is positioned with precision with respect to the light source, in particular in order to receive radiation from the at least one light source.

### TECHNICAL BACKGROUND OF THE INVENTION

The invention relates more particularly to a light module of the type mentioned above in which the light source and the optical component—such as for example an optical reflector, an optical collimator or an optical lens—are positioned indirectly with respect to one another by each being positioned and fastened with precision on a common reference surface belonging for example to a radiator belonging to the light module.

Such precise positioning is particularly important in the case of one or more semiconductor light source(s), and more particularly in the case of what is termed a laser light source.

The light source has to be positioned with small dimensional tolerances in the three axes, in particular of less than 1 millimetre, or even 0.5 mm in particular in the case of a light source the emission light cone of the radiation of which is very small.

The handling, the positioning and the fastening of a laser source are made particularly difficult in view of the design and the shape of the light source, and in particular of the relative fragility of its connection terminals.

The invention aims to propose a solution that enables precise adjustment of the relative position of the semiconductor light source with respect to the associated optical component and that is able in particular to be implemented in the context of the mass production of light modules.

### BRIEF SUMMARY OF THE INVENTION

The invention proposes a light module comprising:

at least one semiconductor light source;

an optical component that is positioned with respect to the light source;

and a reference surface on which the at least one light source and the optical component are fastened,

characterized in that the at least one light source is supported by a mount that is fastened on the reference surface.

According to other features of the light module:

it includes means for adjusting the position of the mount with respect to the reference surface and means for fastening the mount, in the adjusted position, on the reference surface;

the mount includes at least one fastening hole for the passage of an element for fastening the mount on the reference surface;

the fastening element includes a threaded rod that extends axially with radial play through the fastening hole;

the light source includes a housing that is received and positioned in a complementary recess in the mount;

the mount includes two fastening holes, and the recess is formed between the two fastening holes;

the mount includes a central body in which the recess is formed, and two opposite lateral vanes each of which extends from this body and each of which includes a fastening hole;

the housing is mounted so as to be clamped, in particular radially without play, by axial insertion into the recess in the mount;

the housing is mounted in its recess by insertion along an axis parallel to the axis of the threaded rod;

the mount includes means to be gripped by a handling element enabling the mount to be positioned with respect to the reference surface;

the light source includes connection terminals that are offset radially with respect to a central axis of its housing, and the mount includes poka-yoke means that interact with complementary means of the reference surface so as to define a preferred positioning orientation of the mount;

the light source is a laser source, and the light module includes a diffusion screen that is interposed vertically between the mount and the reference surface;

the semiconductor light source belongs to a group including in particular a laser source, at least one laser diode and at least one light-emitting diode;

the optical component belongs to a group including in particular a reflector, a collimator and a lens;

the reference surface belongs to a radiator or a heat sink.

the light source is positioned directly with respect to the mount and indirectly with respect to the optical component that is positioned with respect to the reference surface common to the mount and to the optical component.

### BRIEF DESCRIPTION OF THE FIGURES

Other features and advantages of the invention will become apparent from reading the following detailed description, for an understanding of which reference is made to the appended drawings, in which:

FIG. 1 is a perspective view of a heat sink radiator belonging to an exemplary embodiment of a light module whose upper face forms the reference surface within the meaning of the invention;

FIG. 2 is a perspective view illustrating a laser light source belonging to the light module in association with a mount according to the invention for positioning and fastening the laser light source on the radiator of FIG. 1;

FIG. 3 is a perspective view illustrating the sub-assembly formed by the laser light source and its positioning mount, before this sub-assembly is positioned and fastened on the radiator of FIG. 1;

FIG. 4 is a perspective view illustrating the mount and its laser source in the adjusted position on the radiator and prior to it being fastened on the radiator by way of fastening screws;

FIG. 5 is a perspective view illustrating the radiator with the mount in the adjusted and fastened position, in association with an optical component formed in this case by an optical reflector;

FIG. 6 is a perspective view illustrating the embodiment of a light module according to the invention after the optical reflector has been positioned and fastened on the radiator;

FIG. 7 is a sectional view of the light module through a vertical and transverse plane passing through the axes of the screws for fastening the mount on the radiator;

FIG. 8 is an axial end view of the light module of FIG. 7;

FIGS. 9 and 10 are two perspective views, along different viewing angles, illustrating the sub-assembly formed by the mount equipped with its laser light source;

FIG. 11 is a longitudinal front view of the mount equipped with its laser light source;

FIG. 12 is a perspective bottom view of the mount;

FIG. 13 is a bottom view of the sub-assembly shown in FIG. 11; and

FIG. 14 is a perspective view illustrating the diffusion screen in position on the radiator prior to the installation and fastening of the mount.

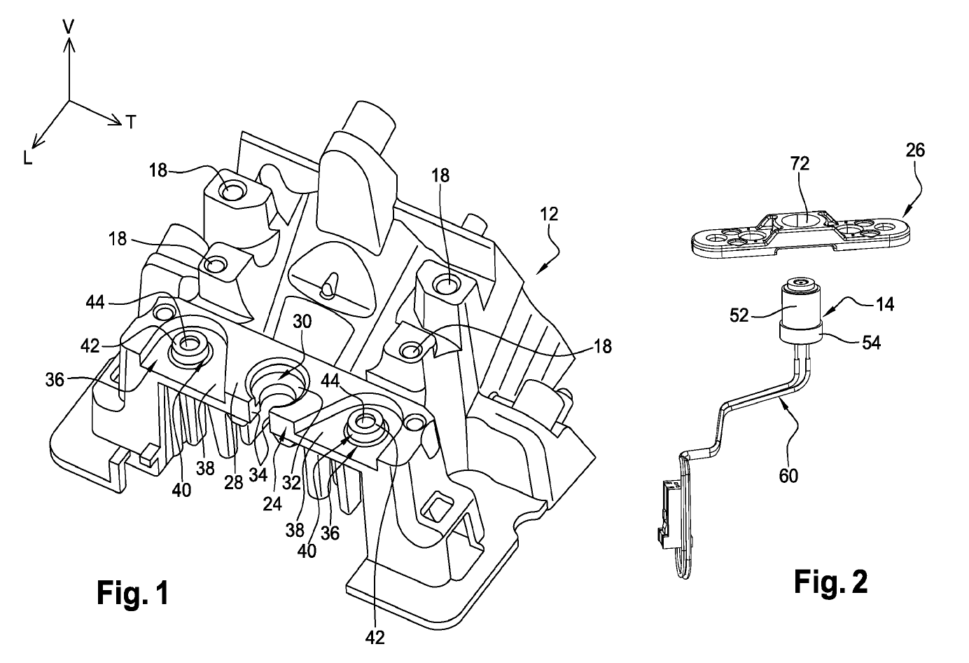

### DETAILED DESCRIPTION OF THE FIGURES

In the remainder of the description, elements having an identical structure or similar functions will be denoted by the same references.

In the remainder of the description, longitudinal, vertical and transverse orientations, indicated by the “L, V, T” trihedron in the figures, will be adopted in a non-limiting manner. A horizontal plane that extends longitudinally and transversely is also defined.

FIG. 6 shows some elements and components belonging to a lighting module light module 10 that includes in particular a radiator 12, a laser light source 14 and an optical reflector 16.

The semiconductor light source of laser type 14 is in particular able to emit light radiation along a main axis of emission A.

The radiator 12, illustrated in FIG. 1, is a component formed by complex shape moulding that, alongside its heat sink function, in this case performs the function of a carrier for the relative positioning and the fastening of the light source 14 and the optical reflector 16.

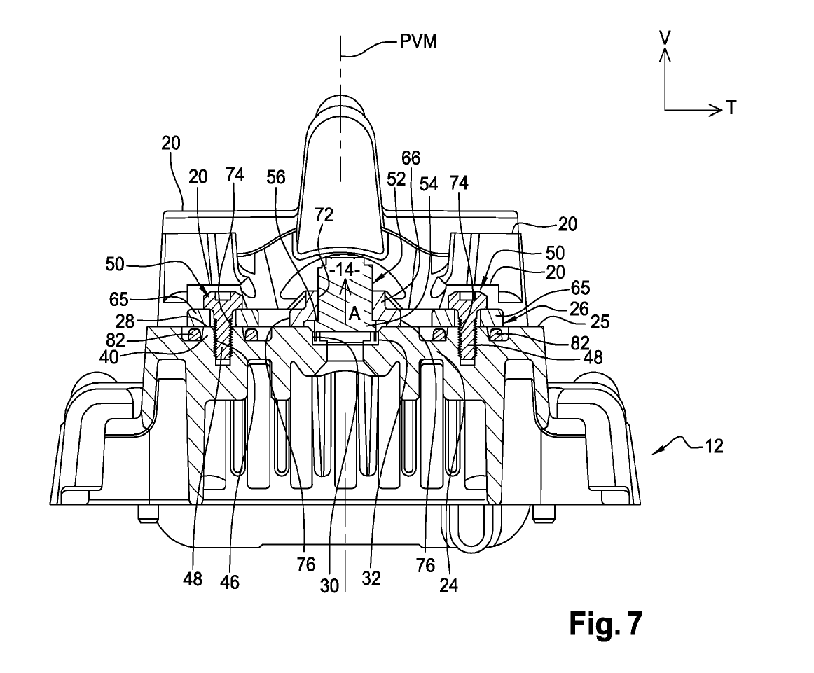

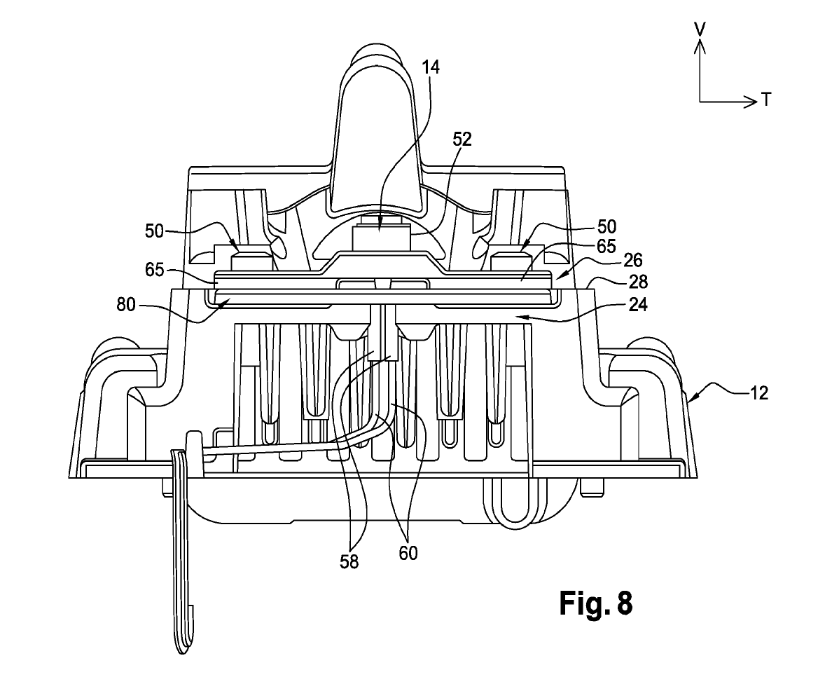

In the embodiment illustrated in the figures, the radiator 12 has a general design symmetry with respect to a median vertical and longitudinal plane PVM indicated in FIG. 7.

The radiator 12 is delimited by an envelope or outer surface with respect to which the light source 14 and the collector 16 are positioned with precision, in particular so as to define a precise relative position of one component with respect to the other.

Thus, at its rear part, the radiator 12 includes, in order to position and fasten the optical collector 16, four positioning and fastening holes 18 each of which is associated with a flat portion 20 of the outer surface of the radiator 12. Each of the holes 18 is able to receive complementary elements 20 of the optical collector 16.

At its front longitudinal part, the radiator 12 includes a portion 24 forming a connector plate for fastening the laser light source 14 by way of a mount 26 according to the invention.

The connector plate 24 is delimited by a flat upper face 28, which is in this case horizontal and has a rectangular overall profile whose length extends along the transverse axis T.

The connector plate 24 includes, at its centre, a stepped cylindrical recess 30, in this case with a circular cross section with a vertical overall axis of orientation.

The recess 30 is delimited vertically downwards by an annular base 32.

The stepped recess 30 is radially open, in this case in the longitudinal direction towards the front, in the form of a vertical passage 34 delimited by two opposite vertical and longitudinal sides.

Symmetrically, on either side of the stepped recess 30, the connector plate 24 includes two cavities 36 in the form of counterbores, each of which is delimited by a horizontal base 38.

Substantially in the centre of each cavity 36, the connector plate 24 includes a fastening pad 40 of frustoconical general shape that is delimited by a horizontal annular upper bearing face 42, these two surfaces 42 being coplanar with the horizontal upper face 28 of the connector plate 24.

Each fastening pad 40 includes a central orifice 44 that is able to receive, through screwing, a threaded rod 48 belonging in this case to a fastening screw 50.

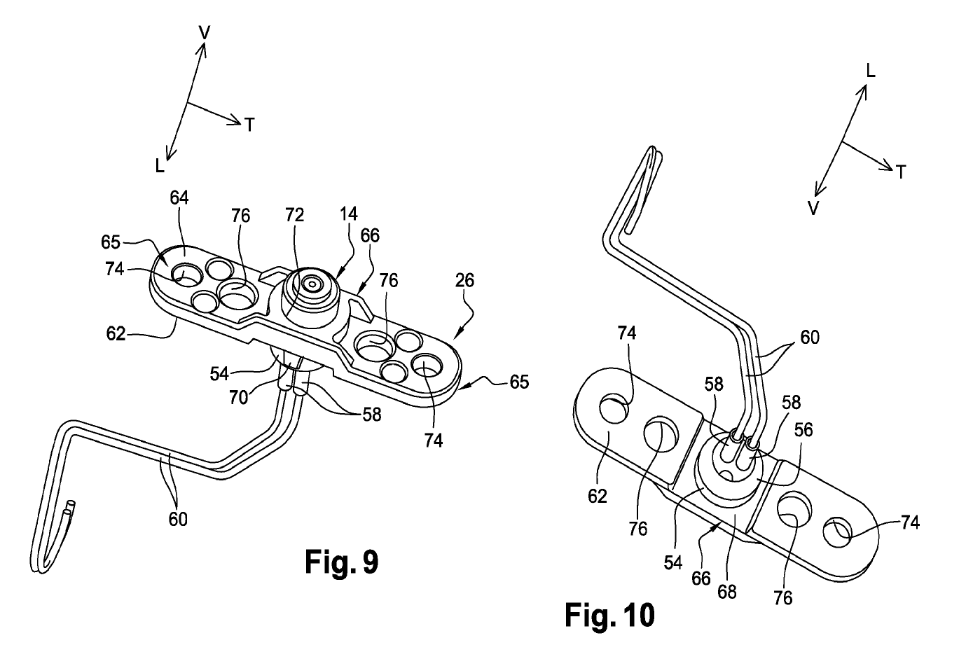

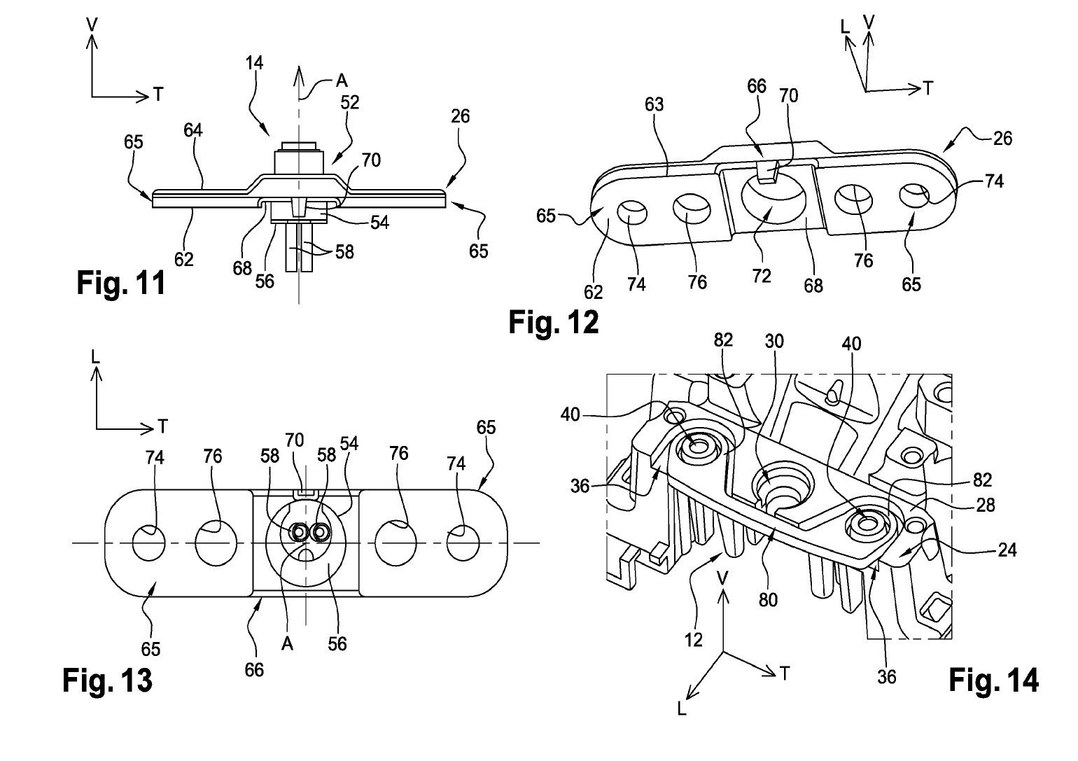

The light source 14 is in this case a laser source, which is in particular illustrated in detail in FIGS. 7, 9, 10, 11 and 13.

The laser source 14 includes a housing 52 that in this case has a cylindrical general shape with a circular cross section and that includes a lower collar 54 delimiting an upwardly oriented annular radial shoulder 56.

The housing 52 is delimited by a flat lower horizontal face 56 in the general shape of a disc.

The laser light source 14 includes two connection terminals 58 for its supply of electric power, each of which terminals is extended by a power supply wire 60.

Each connection terminal 58 extends vertically downwards from the lower face 56.

As illustrated with precision in FIG. 13, the two connection terminals 58 are offset radially eccentrically with respect to the general central axis A of the housing 52, which axis corresponds substantially to the main axis of emission of the light source 14.

Each of the connection terminals 58, when the light source 14 is positioned with respect to the radiator 12, is offset transversely and longitudinally forwards with respect to the axis A.

According to the invention, the housing 52 of the laser light source 14 is mounted, positioned and fastened on the radiator 12 by way of the mount 26 on which the housing 52 of the laser source 14 is mounted and fastened: the mount 26 itself being positioned and fastened on the upper face 28 of the connector plate 24.

The mount 26 is in this case in the general shape of a sheet with a horizontal orientation and with a rectangular general profile whose ends are rounded.

The mount 26 is delimited vertically by a flat horizontal lower face 62 and by a flat horizontal upper face 64.

In its central part, the mount 26 includes a central body 66 formed overall with an excess thickness with respect to the upper face 64.

The mount 26 thus takes the form of a central body 66 that is extended by two lateral vanes 65 with a transverse orientation and each of which is in the form of a sheet.

The central body 66 is delimited vertically downwards by a flat horizontal base 68 that is offset vertically upwards with respect to the plane of the lower face 62.

In the vicinity of the front longitudinal edge 63 of the mount 26, the central body 66 includes an indexing finger 70 that extends vertically downwards and that is able to be received in the passage 34 of the connector plate 24 of the radiator 12 so as to form a means for poka-yoking the general orientation of the mount 26 with respect to the connector plate 24.

The central body 66 includes a cylindrical central recess 72 with a circular profile and with a vertical axial orientation orthogonal to the plane of the upper face 64.

The central recess 72 is the recess in which the body 52 of the laser light source 14 is received and mounted.

The laser light source 14, by way of its housing 52, occupies a given fixed position with respect to the mount 26 along the three axes.

To this end, the body 52 may be force-fitted in the central recess 72 and/or fastened by adhesive bonding.

The vertical position of the housing 52 with respect to the mount 26 is defined by the radial shoulder 56 upwardly coming into axial abutment with the portion opposite the base 68 of the central body 66.

When the housing 52 is assembled with and joined to the mount 26, the method for mounting it also consists in ensuring a given angular orientation of the housing 52 about its axis with respect to the mount 26 in such a way that, as illustrated in FIG. 13, the connection terminals 58 are eccentric and oriented as described above, in particular longitudinally forwards facing the indexing finger 70.

In the vicinity of each of its opposite transverse ends, the mount 26 includes a cylindrical fastening through-hole 74.

Each fastening hole 74 is able to be passed through axially by the threaded rod 48 of an associated fastening screw 50.

The inner diameter of each fastening hole 74 is markedly greater than the outer diameter of the threaded rod 48, such that the latter is received in the associated hole 74 with radial play in order, as will be explained hereinafter, to enable adjustment of the position of the mount 26 with respect to the connector plate 24 in the horizontal plane L, T.

The lower collar 54 of the housing 52 also has radial play in the recess 30 in the connector plate 24.

Lastly, each lateral vane 65 includes, between the fastening hole 74 and the central body 66, a cylindrical through-hole 76 that is a grip hole for enabling the mount 26 to be handled with respect to the radiator 12, for example by way of a motorized handling head (not shown).

Optionally, and in particular in the case of using a light source of laser type, the optical module 10 is equipped with a diffuser screen 80, which is illustrated in detail in FIG. 14.

To mount and fasten it, the screen 80 includes two opposite transverse tabs 82, each of which is received in an associated recess 36 of the connector plate 24 of the radiator 12, each tab 82 being passed through by an associated pad 40.

The precise positioning and the fastening of the light source 14 and of the optical reflector 16 on the radiator 12 is achieved as follows.

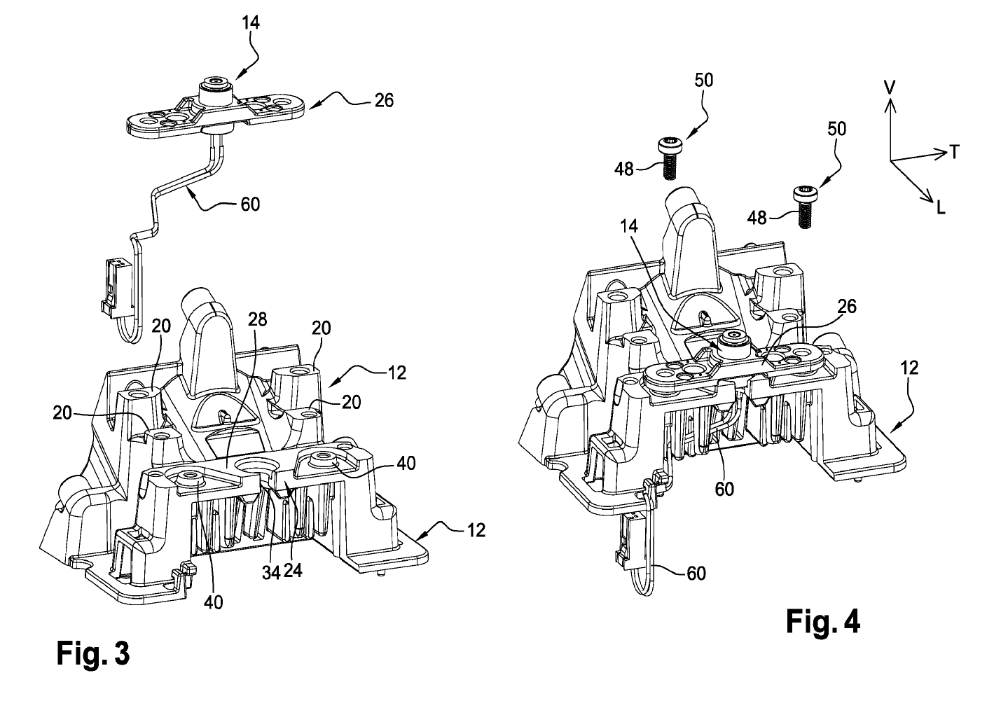

After having assembled and fastened the light source 14 and the mount 26, the sub-assembly is brought, with respect to the radiator 12, into the position illustrated in FIG. 3.

Starting from this position, the mount 26, with its indexing finger 70, is brought into position, with respect to the connector plate 24, with its lower face 62 bearing horizontally flat on portions facing the horizontal upper face 28 of the connector plate 24.

Upon this installation, the passage 34 receives the indexing finger 70.

At this juncture, it is possible to install the desired fastening screws 50 partially without their threaded rod 48 into a fastening orifice 46, without vertical clamping of the mount 26.

As a variant, the fastening screws 50 may be installed and screwed after the step of adjusting the positioning of the mount 26 with respect to the connector plate 24.

The handling of the mount 26, for example using a manipulating robot interacting with the grip holes 76, then makes it possible, as outlined in FIG. 4, to position the mount 26 with precision in the horizontal plane with respect to the connector plate 24 of the radiator 12 so as to position the general axis of emission of the light beam of the laser light source 14 with precision.

Such precise positioning is able to be ensured by any known means, for example by imaging means.

When the precise position of the mount 26 with respect to the connector plate 24 is achieved, the fastening screws 50 are then fully screwed so as to ensure that the mount 26 is immobilized on the connector plate 24 by vertical clamping.

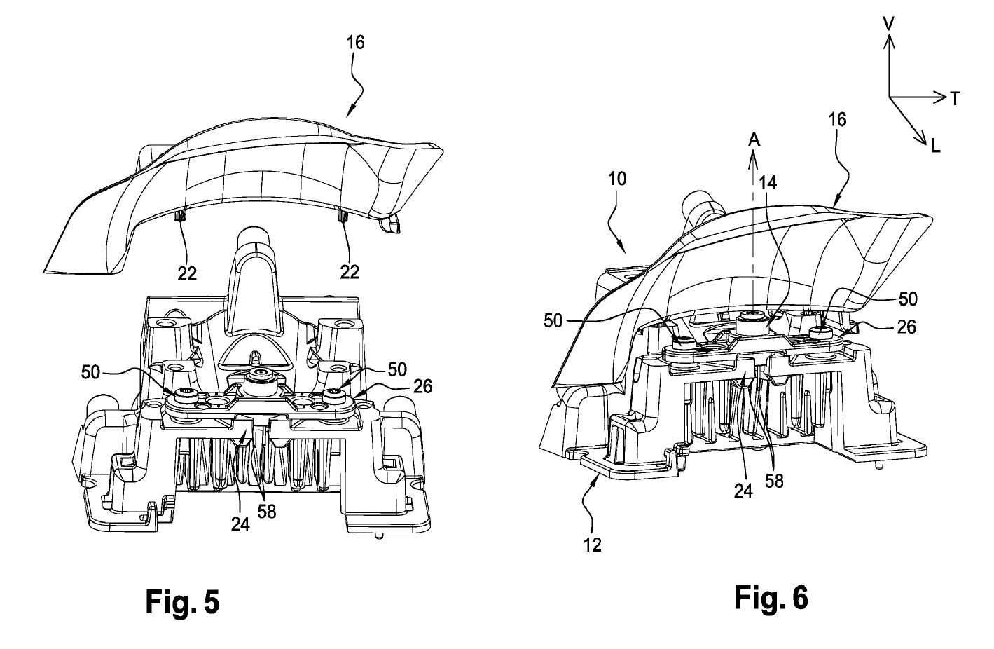

At this juncture, illustrated in FIG. 5, by way of its mount 26, the laser light source 14 is positioned with all the desired precision with respect to the radiator 12.

The following step then consists in positioning and fastening the optical reflector 16 on the radiator 12 so as to precisely position and fasten the optical reflector 16 with respect to the laser light source 14.

Thus, according to the design that has just been described, the light source 14 is positioned directly with respect to the mount 26, which performs the function of a reference surface for the light source, and it is positioned indirectly with respect to the optical reflector 16, which is itself positioned with respect to the reference surface formed by the radiator 12 that is the reference surface common to the mount 26 and to the optical reflector 12.

The invention is not limited to the embodiment that has just been described.

Numerous variants are possible and able to be contemplated without departing from the scope of the invention.

The mount 26 may be produced for example by moulding of any material, of plastic or of metal, in particular of aluminium alloy, of Zamac, etc., its material being chosen in particular depending on deformation constraints and on thermal expansion.

The mount 26 may include one or more light sources, each of which is positioned with precision with respect to the mount 26.

The light source 14 may include a non-cylindrical housing of any other shape, the mount 26 including a recess complementary to the shape of the housing of the light source.

The mount 26 may also be produced as a single component with all or some of the housing of the light source.

The mount 26 may also be joined to the housing of the light source by overmoulding around the latter.

1. Light module, for lighting and/or signalling, for a motor vehicle, comprising:
at least one semiconductor light source;
an optical component that is positioned with respect to the light source;
and a reference surface on which the at least one light source and the optical component are fastened,
wherein the at least one light source is supported by a mount that is fastened on the reference surface.

2. Light module according to claim 1, wherein the light module includes means for adjusting the position of the mount with respect to the reference surface and means for fastening the mount, in the adjusted position, on the reference surface.

3. Light module according to claim 1, wherein the mount includes at least one fastening hole for the passage of an element for fastening the mount on the reference surface.

4. Light module according to claim 3, wherein the fastening element includes a threaded rod that extends axially with radial play through the fastening hole.

5. Light module according to claim 1, wherein the light source includes a housing that is received and positioned in a complementary recess in the mount.

6. Light module according to claim 5, wherein the mount includes two fastening holes, and wherein the recess is formed between the two fastening holes.

7. Light module according to claim 6, wherein the mount includes a central body wherein said recess is formed, and two opposite lateral vanes each of which extends from this central body and each of which includes a fastening hole.

8. Light module according to claim 5, wherein the housing is mounted so as to be clamped, radially without play, by axial insertion into the recess in the mount.

9. Light module according to claim 8, wherein the housing is mounted in its recess by insertion along an axis parallel to the axis of the threaded rod.

10. Light module according to claim 1, wherein the mount includes means to be gripped by a handling element enabling the mount to be positioned with respect to the reference surface.

11. Light module according to claim 8, wherein the light source includes connection terminals that are offset radially with respect to a central axis of its housing, and wherein the mount includes poka-yoke means that interact with complementary means of the reference surface so as to define a preferred positioning orientation of the mount.

12. Light module according to claim 1, wherein the light source is a laser source, and wherein the light module includes a diffusion screen that is interposed vertically between the mount and the reference surface.

13. Light module according to claim 1, wherein the semiconductor light source belongs to a group including a laser source, at least one laser diode and at least one light-emitting diode.

14. Light module according to claim 1, wherein the reference surface belongs to a radiator or a heat sink.

15. Light module according to claim 1, wherein the light source is positioned directly with respect to the mount and indirectly with respect to the optical component that is positioned with respect to the reference surface common to the mount and to the optical component.

16. Light module according to claim 2, wherein the light source includes a housing that is received and positioned in a complementary recess in the mount.

17. Light module according to claim 3, wherein the mount includes two fastening holes, and wherein the recess is formed between the two fastening holes.

18. Light module according to claim 5, wherein the housing is mounted in its recess by insertion along an axis parallel to the axis of the threaded rod.
